(19) United States
(12) Patent Application Publication
(10) Pub. No.: US 2023/0284868 A1
(43) Pub. Date: Sep. 14, 2023

(54) Portable Rack for Cleaning Parts

(71) Applicant: Randy Greene, White Pine, TN (US)

(72) Inventor: Randy Greene, White Pine, TN (US)

(21) Appl. No.: 17/691,558

(22) Filed: Mar. 10, 2022

(51) Int. Cl. A47L 19/04; A47L 17/00; A47J 37/07

(52) U.S. Cl. CPC A47L 19/04; A47L 17/00; A47J 37/0786

(57) ABSTRACT

A portable rack for hanging parts thereon to wash, the rack including three leg members each having a top end and a bottom end, the top ends of the three leg members being configured to be rotatably coupled proximate one another such that the bottom ends of the three leg members are selectively rotatable outward to form a tripod arrangement, a plurality of openings formed along a length of each of the leg members, and a plurality of hook members configured to be selectively installed in, and removed from, the openings in the leg members so as to selectively hang parts therefrom.

### CROSS-REFERENCE TO RELATED APPLICATIONS

Not applicable.

### FIELD OF INVENTION

The present general inventive concept relates to a parts hanging rack, and, more particularly, to a portable and collapsible parts hanging rack that can be selectively expanded from a storage to a tripod arrangement.

### BACKGROUND

When cleaning various parts and accessories around the home, often the most onerous part of the process is finding a suitable place to position the parts during the cleaning operation. For example, one item that that is fairly ubiquitous at many homes is a barbecue grill. The actual grill portion of the barbecue grill is notoriously difficult to keep clean, and even with regular brushing will need to be removed and washed from time to time. These grills are extremely messy, and are often large and heavy, and thus it is often very difficult to find a place at which to clean them, much less perform the cleaning. Some people will find a place to lean the grill against another fixed or otherwise standing item during cleaning, but that can lead to problems such as kicking up dirt and gravel on the grill being cleaned, and/or getting the fixture upon which the grill is leaning dirty with grime from the grill. Another problem is having to eventually hold the grill up to clean off the dirt that ended up on the grill during the initial cleaning, which is difficult. Finding a place to then dry the grill, or to allow the grill to air dry, is yet another problem, as the portion of the grill that may be touching the ground, sidewalk, etc., will not be as effectively dried, and may be getting dirty yet again. Such concerns are warranted for a host of different types of parts. For example, getting dirt or gravel on auto parts could cause serious problems when the parts are then reassembled for operation. Therefore, for at least these reasons, it would be beneficial to have a support rack upon which parts such as grills may be mounted or suspended for a cleaning and drying operation, and that such a support rack be conveniently portable so that it does not have to be a permanent or dedicated structure.

### BRIEF SUMMARY

According to various example embodiments of the present general inventive concept, a portable rack for hanging parts thereon to wash, dry, etc., is provided, the rack being configured as a collapsible stand upon which hooks or other hanging members can be arranged and from which one or more parts can be suspended for such work to be performed.

Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved by providing a portable rack for hanging parts thereon to wash, the rack including three leg members each having a top end and a bottom end, the top ends of the three leg members being configured to be rotatably coupled proximate one another such that the bottom ends of the three leg members are selectively rotatable outward to form a tripod arrangement, a plurality of openings formed along a length of each of the leg members, and a plurality of hook members configured to be selectively installed in, and removed from, the openings in the leg members so as to selectively hang parts therefrom.

The foregoing and/or other aspects and advantages of the present general inventive concept may also be achieved by providing a portable rack for hanging parts thereon to wash, the rack including three leg members each having a top end and a bottom end, the top ends of the three leg members being configured to be rotatably coupled proximate one another such that the bottom ends of the three leg members are selectively rotatable outward from a storage position to form a tripod arrangement, and the leg members being angled by a longitudinal bend to have two outer surfaces facing in different directions, a plurality of openings formed along a length of each outer surface of each of the leg members, and a plurality of hook members configured to be selectively installed in, and removed from, the openings in the leg members so as to selectively hang parts therefrom, wherein the three leg members are configured such that parts may be hung from three sides of the rack simultaneously.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a portable rack for hanging parts thereon according to an example embodiment of the present general inventive concept;

FIGS. 2A-B illustrate the interaction of the hook members and the rack openings of the rack illustrated in FIG. 1;

FIG. 3 illustrates the rack of FIG. 1 with a grill mounted on the hook members;

FIG. 4 illustrates a portion of a portable rack for hanging parts thereon according to another example embodiment of the present general inventive concept;

FIG. 5 illustrates the rack of FIG. 1 in a storage arrangement according to an example embodiment of the present general inventive concept; and

FIG. 6 illustrates a portion of a portable rack for hanging parts thereon according to still another example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, a portable rack is provided for hanging parts thereon to wash, dry, etc., the rack being configured as a collapsible stand upon which hooks or other hanging members can be arranged and from which one or more parts can be suspended for such work to be performed. In various example embodiments described herein, the rack includes three leg members rotatably coupled at top ends thereof so as to form a collapsible tripod which can provide three different mounting planes, one on each side, on which the parts can be mounted. While many of the example embodiments described herein discuss the grill portion of a barbecue grill as being the part that is suspended or mounted on the rack to be cleaned, it is understood that a host of different items can be mounted on the rack, and as such will be generically referred to herein as “parts.” Additionally, while the described embodiments typically discuss cleaning operations performed on these parts, it will be evident to one skilled in the art that such a rack could also be used to hang parts on to dry, to be painted, to have maintenance or other work performed thereon, and so on. Such example embodiments of the racks can be formed of relatively lightweight materials so as to be easily portable, so that a user can conveniently bring out and install the rack for used in parts cleaning or other operations, and then easily collapse and store the rack until it is next needed. In various example embodiments, such a rack may be 4-5 feet tall when placed in the tripod arrangement for mounting/hanging parts thereon.

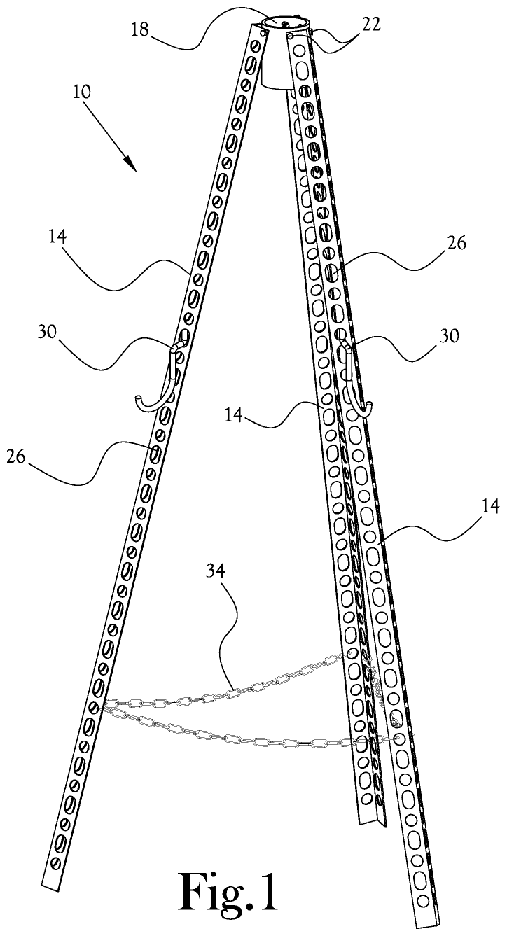

FIG. 1 illustrates a portable rack for hanging parts thereon according to an example embodiment of the present general inventive concept. As illustrated in FIG. 1, the example embodiment rack 10, which may be referred to as a rack assembly or tripod rack herein, is illustrated in the deployed tripod position and ready for use to hang parts thereon. The rack 10 of this example embodiment includes three leg members 14 that are rotatably coupled proximate their respective top ends such that the bottom ends of the leg members 14 are selectively rotatable outward to form a tripod, as illustrated in FIG. 1. In this tripod position, which may be referred to herein as the “use” position, the rack 10 is able to stand on its own. Thus, a user can move the rack 10 to any place the user wishes to perform cleaning, painting, etc., operations, and easily configure the rack in position for use by simply rotating the bottom ends of the leg members 14 outward. In this example embodiment the top ends of the leg members are all rotatably coupled to a top member 18 which serves as a connecting point and spaces the top ends of the leg members 14 somewhat away from one another to provide a relatively simple coupling arrangement. In various other example embodiments the top ends of the leg members 14 may be rotatably coupled directly to one another, rather than through a top member. In this example embodiment the top ends of the leg members are rotatably coupled to the top member 18 by a plurality of coupling members 22 such as, for example, screws or bolts, about which the top ends of the leg members may pivot or rotate around. In the example embodiment the outward rotation of the bottom ends of the leg members 14 is limited by a span limiting member 34, which in this example embodiment is a length of chain, that connects each leg member 14 to the other two leg members 14, and limits how far away from one another the second ends of the leg members 14 may be positioned, and thus sets the overall size of the base of the tripod. In various example embodiments the span limiting members 34 may be adjustable in length, so that a user can selectively adjust the base size of the tripod or use arrangement of the rack 10. For example, the span limiting members 34 may have hooks or other such securing members at the ends thereof to interact with the leg members 14, or to pass through openings 26 formed in the leg members 14 to then double back and interact with a point on the span limiting member 34, such as a chain loop, if the user wants a smaller base of the tripod arrangement. In various example embodiments the outward rotation of the bottom ends of the leg members 14 may be fixed by a mechanical stop arranged at the rotatable couplings at the top ends of the leg members 14.

As illustrated in FIG. 1, each of the leg members 14 are formed with a plurality of openings 26 formed along a length thereof to selectively receive hook members 30 on which parts may be hung. In various example embodiments the openings 26 may be formed along substantially the entire length of the leg members 14, such as illustrated in FIG. 1. In various example embodiments the openings may be of two or more sizes, so as to accommodate differently sized hooks that may be configured for different items, weights, etc. Thus, the hooks 30 can be selectively placed at a host of different positions along the leg members 14 according to the wish of the user, based on the size of parts to be hung, or quantity, and so on. In the example embodiment illustrated in FIG. 1, the leg members 14 are formed as angled legs with a bend running along the length thereof. With such a configuration, the leg members 14 effectively have two outer “sides” along which the hook members 30 may be suspended, providing more possibilities of arrangements for the user and making it easier to employ all three sides of the “tripod.” As illustrated in FIG. 1, two hook members 30 have been attached on corresponding outer surfaces of two of the leg members 14 so as to face one side of the tripod, so that a large part can be supported by both of the hook members 30. Additional hook members 30 can be attached on the other sides of the rack 10, as well as additional upper and lower positions on the same side of the rack 10. In the example embodiment illustrated in FIG. 1 both “sides” of the bent leg members 14 are rotatably coupled to the top member 10 to provide a stable and secure rotating or pivoting connection. In various example embodiments the angle of the bend of the leg members 14 may be approximately 60 degrees, which may provide more of a flat outer surface on each side of the rack 10 to provide additional support for large parts that stretch across two leg members 14. In other various example embodiments the leg members 14 may be formed in a host of different configurations, such as a round leg members with openings formed about a longitudinal axis of the leg members and along the length of the leg members.

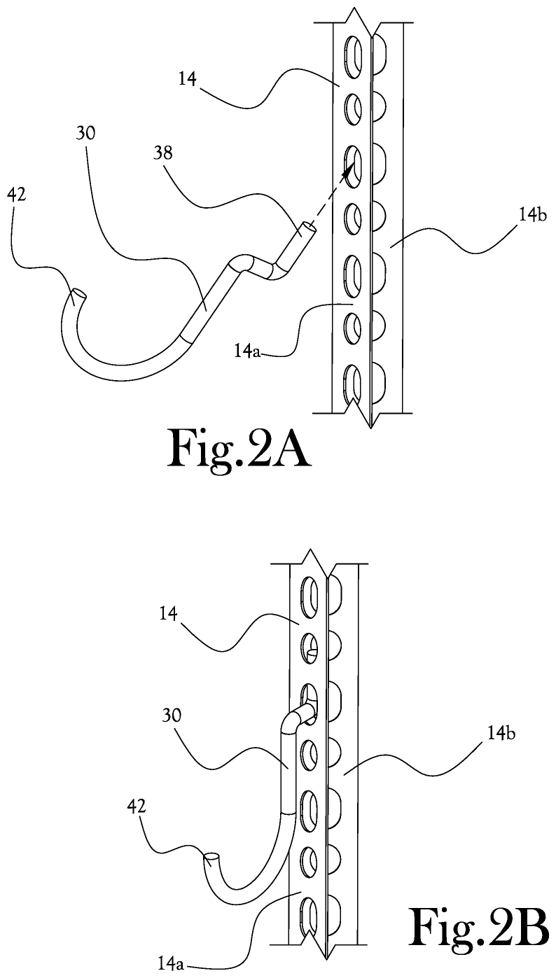

FIGS. 2A-B illustrate the interaction of the hook members 30 and the rack openings 26 of the rack 10 illustrated in FIG. 1. In this example embodiment each of the hook members 30 is configured to have a first end 38 and a second end 42 both formed as hook portions. The first end 38 of the hook member 30 is configured to couple or hook the hook member 30 to the openings 26 by passing therethrough and then contacting the leg member 14 as illustrated, and the second end 42 of the hook member 30 is configured with a larger sized hook portion on which a part may be hunk or mounted. Thus, a user can easily place the hook member 30 at a selected spot by simply inserting the first end 38 through the desired opening 26, and just as easily remove the hook member 30 by reversing the operation. This provides quick and convenient selective placement of the hook members 30 at the desired positions on the leg members 14 of the rack 10. In the example embodiment illustrated in FIGS. 2A-B, the two outer surfaces of the leg member 14 are designated as 14a and 14b. Due to the bent configuration of the leg member 14 in this example embodiment, the user can hang two hook members 38 at the same height on each of the leg members 14, providing a double hook support arrangement on each of the three sides of tripod rack 10, if so desired. In other various example embodiments the hook members may be configured in a host of different configurations, such as, for example, the first end 38 being bent downward or in some other direction than that illustrated in FIGS. 2A-B, or the hook members 30 being provided with multiple second hook ends 42 that may be spaced apart horizontally and/or vertically for additional support points, and so on.

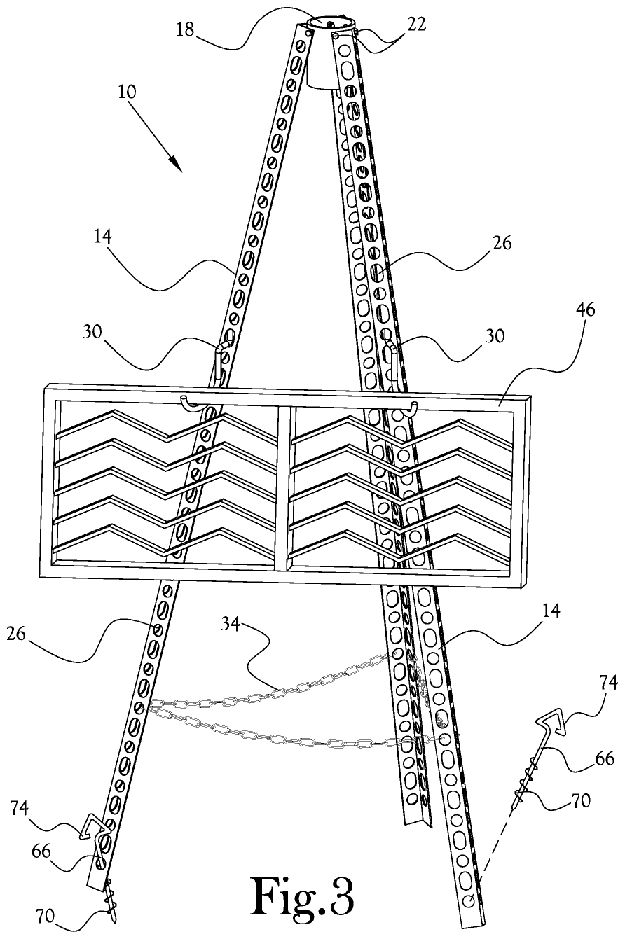

FIG. 3 illustrates the rack 10 of FIG. 1 with a barbecue grill 46 mounted on the hook members 30. As illustrated in FIG. 3, the user has placed two hook members 30 at the same height and on corresponding outer surfaces of the leg members 14, and then suspended the barbecue grill 46 on the two hook members 30 for a cleaning operation. The barbecue grill 46 can thus be easily placed at a desired position off of the ground, sprayed with water and/or other detergents, scrubbed, and left to dry all at the same convenient position. Multiple such grills could be suspended on each of three sides of the rack 10. As previously described, such a barbecue grill 46 is merely one part or type of part that can be mounted on the rack 10. Typically, the mere loading of parts on the tripod rack 10 may provide enough weight to hold the rack 10 in place. However, as illustrated in FIG. 3, one or more anchor members 66 may be provided to anchor the rack 10 to the ground so that a user can perform pressure washing or other operations that could have the force to otherwise topple the rack 10. In this example embodiment, a plurality of anchor members 66 are configured with a threaded portion 70 that can pass through one of the lower openings 26 of a leg member 14 and then be screwed into the ground to anchor that leg member 14 down. The anchor members 66 are configured with a handle portion 74 that is larger than the openings 26, so that the leg members 14 cannot slip over the top of the anchor members 66. Various example embodiments may provide one or more such anchor members in a number of different configurations. Various example embodiments may provide a dedicated opening, such as on an inwardly or outwardly bent tab at a bottom end of the leg members 14, through which the anchor members 66 may be passed through. Also, due to the tripod configuration of the rack 10 when in use, a space is provided on the ground between the leg members 14 that can accommodate a heating unit (not shown) which can aid in the drying operation of parts that have been washed, painted, etc. Such a heating unit may also be provided with support members that could interact with the openings on the leg members 14 to hold the heating in a stable position during a heating operation.

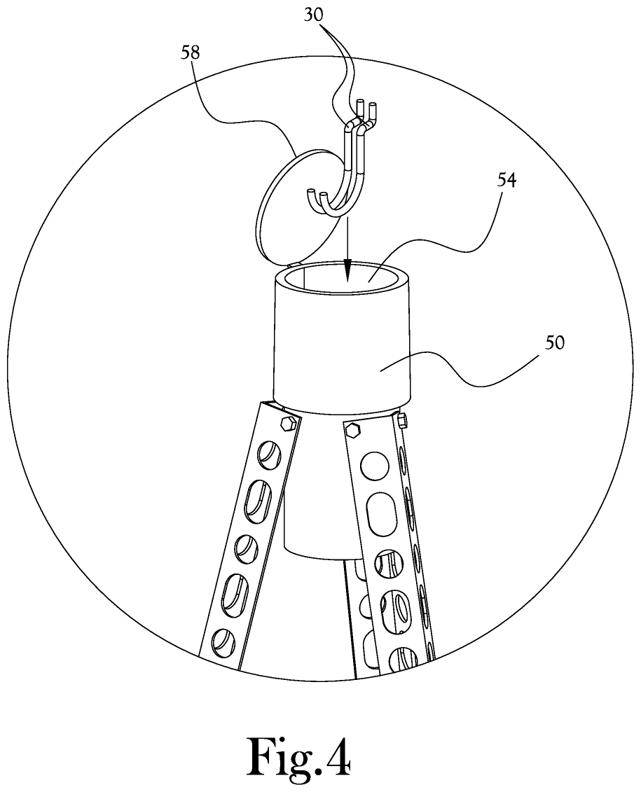

FIG. 4 illustrates a portion of a portable rack for hanging parts thereon according to another example embodiment of the present general inventive concept. In the example embodiment illustrated in FIG. 4, a hook receptacle 50 has been provided in which the hook members 30 may be stored when not being used. In this example embodiment the hook receptacle is formed as a receiving portion or cup 54 with a lid 58 that can be selectively opened and closed to retrieve or store the hook members 30, but a host of other configurations could be employed without departing from the scope of the present general inventive concept. In various example embodiments the hook receptacle 50 may be formed integrally, or attached to, the top member 18 of the rack assembly, or may also function as the top member itself.

FIG. 5 illustrates the rack 10 of FIG. 1 in a storage arrangement according to an example embodiment of the present general inventive concept. As illustrated in FIG. 5, the user has rotated the bottom ends of the leg members 14 to points at which they are proximate one another, such that the leg members 14 may be substantially parallel for storage. In various example embodiments the top member 18 may provide additional support, due to its length, for preventing the bottom ends of the leg members 14 from moving too far inward and getting tangled. In this example embodiment a plurality of straps 62 have been provided to secure the leg members 14 in the stored position. In other example embodiments a host of different storage members may be employed, such as a sleeve that either wraps around the collapsed rack or receives the collapsed rack through one end thereof, or a rigid tube that receives the collapsed rack, and so on. Thus, the rack assembly 10 may be easily collapsed to a conveniently sized unit for transport and storage.

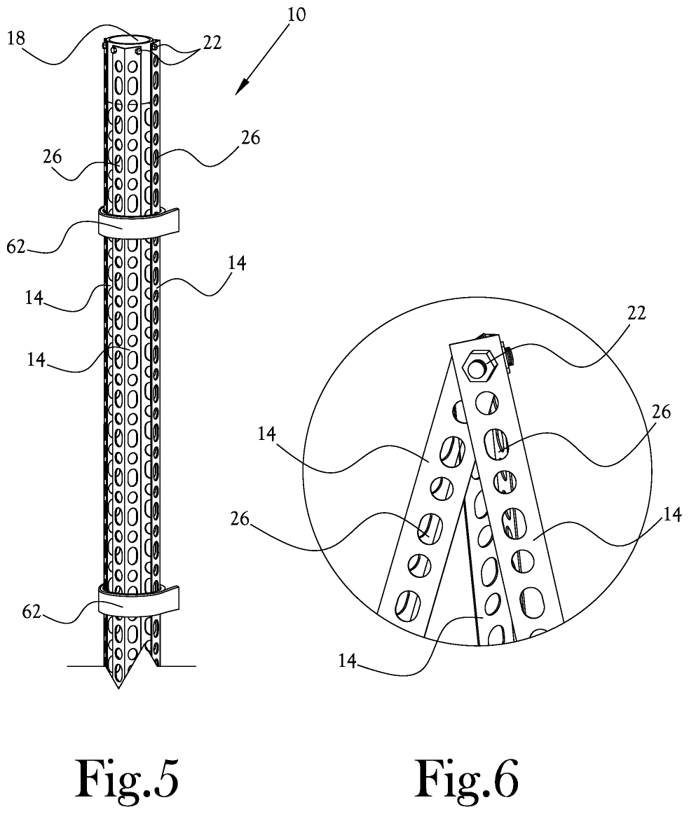

FIG. 6 illustrates a portion of a portable rack for hanging parts thereon according to still another example embodiment of the present general inventive concept. As previously described, the example embodiment illustrated in FIG. 6 omits the top member 18, and the top ends of the leg members 14 are rotatably couple directly to one another with the coupling bolts or members 22. Such an assembly may provide an even smaller diameter of the overall assembly when collapsed into the storage position. It is noted that other coupling members and/or arrangements may be provided without departing from the scope of the present general inventive concept.

Various example embodiments of the present general inventive concept may provide a portable rack for hanging parts thereon to wash, the rack including three leg members each having a top end and a bottom end, the top ends of the three leg members being configured to be rotatably coupled proximate one another such that the bottom ends of the three leg members are selectively rotatable outward to form a tripod arrangement, a plurality of openings formed along a length of each of the leg members, and a plurality of hook members configured to be selectively installed in, and removed from, the openings in the leg members so as to selectively hang parts therefrom. The top ends of the three leg members may be rotatably coupled directly to one another. The rack may further include a top member to which the top ends of the three leg members are rotatably coupled. The rack may further include a hook member storage portion proximate the top member and configured to receive the hook members therein. The hook member storage portion may be formed integrally with the top member. The hook member storage portion may include a lid with which to selectively open and close the hook member storage portion. The rack may further include one or more anchor members configured to be passed through one of the openings and inserted into the ground to anchor the rack. The rack may further include a heating unit configured to be placed between the bottom ends of the three leg members when placed in the tripod arrangement to provide heat to parts hanging on the rack. The rack may further include a plurality of span limiting members configured to limit a distance between the bottom ends of the leg members when rotated outward to form the tripod arrangement. The three leg members may be rotatably coupled proximate the top ends such that the bottom ends are proximate one another when collapsed to a storage arrangement. The rack may further include a storage container configured to store the rack therein when the leg members are collapsed to the storage arrangement. The rack may further include one or more strap members to bind the leg members together when collapsed to the storage arrangement. The leg members may be configured such that at least some of the openings in each leg member face different directions. Each of the leg members may be configured with at least one longitudinal bend so as to form at least two outer surfaces facing different directions. The plurality of openings may be formed along each of the at least two outer surfaces of each leg member. Each of the outer surfaces of each leg member may face in a substantially same direction as one of the outer surfaces of an adjacent leg member. Each of the hook members may be formed with a first end configured to interact with the openings formed in the leg members to suspend the hook member therefrom, and a second end configured to suspend a part therefrom. The rack may further include a plurality of differently sized and/or arranged hook members configured to hang differently configured parts therefrom. The plurality of openings may be provided in at least two different sizes to accommodate differently configured hook members.

Various example embodiments of the present general inventive concept may provide a portable rack for hanging parts thereon to wash, the rack including three leg members each having a top end and a bottom end, the top ends of the three leg members being configured to be rotatably coupled proximate one another such that the bottom ends of the three leg members are selectively rotatable outward from a storage position to form a tripod arrangement, and the leg members being angled by a longitudinal bend to have two outer surfaces facing in different directions, a plurality of openings formed along a length of each outer surface of each of the leg members, and a plurality of hook members configured to be selectively installed in, and removed from, the openings in the leg members so as to selectively hang parts therefrom, wherein the three leg members are configured such that parts may be hung from three sides of the rack simultaneously.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A portable rack for hanging parts thereon to wash, the rack comprising:
three leg members each having a top end and a bottom end, the top ends of the three leg members being configured to be rotatably coupled proximate one another such that the bottom ends of the three leg members are selectively rotatable outward to form a tripod arrangement;
a plurality of openings formed along a length of each of the leg members; and
a plurality of hook members configured to be selectively installed in, and removed from, the openings in the leg members so as to selectively hang parts therefrom.

2. The rack of claim 1, wherein the top ends of the three leg members are rotatably coupled directly to one another.

3. The rack of claim 1, further comprising a top member to which the top ends of the three leg members are rotatably coupled.

4. The rack of claim 3, further comprising a hook member storage portion proximate the top member and configured to receive the hook members therein.

5. The rack of claim 4, wherein the hook member storage portion is formed integrally with the top member.

6. The rack of claim 4, wherein the hook member storage portion includes a lid with which to selectively open and close the hook member storage portion.

7. The rack of claim 1, further comprising one or more anchor members configured to be passed through one of the openings and inserted into the ground to anchor the rack.

8. The rack of claim 1, further comprising a heating unit configured to be placed between the bottom ends of the three leg members when placed in the tripod arrangement to provide heat to parts hanging on the rack.

9. The rack of claim 1, further comprising a plurality of span limiting members configured to limit a distance between the bottom ends of the leg members when rotated outward to form the tripod arrangement.

10. The rack of claim 1, wherein the three leg members are rotatably coupled proximate the top ends such that the bottom ends are proximate one another when collapsed to a storage arrangement.

11. The rack of claim 10, further comprising a storage container configured to store the rack therein when the leg members are collapsed to the storage arrangement.

12. The rack of claim 10, further comprising one or more strap members to bind the leg members together when collapsed to the storage arrangement.

13. The rack of claim 1, wherein the leg members are configured such that at least some of the openings in each leg member face different directions.

14. The rack of claim 1, wherein each of the leg members are configured with at least one longitudinal bend so as to form at least two outer surfaces facing different directions.

15. The rack of claim 14, wherein the plurality of openings are formed along each of the at least two outer surfaces of each leg member.

16. The rack of claim 14, wherein each of the outer surfaces of each leg member faces in a substantially same direction as one of the outer surfaces of an adjacent leg member.

17. The rack of claim 1, wherein each of the hook members are formed with a first end configured to interact with the openings formed in the leg members to suspend the hook member therefrom, and a second end configured to suspend a part therefrom.

18. The rack of claim 1, further comprising a plurality of differently sized and/or arranged hook members configured to hang differently configured parts therefrom.

19. The rack of claim 1, wherein the plurality of openings are provided in at least two different sizes to accommodate differently configured hook members.

20. A portable rack for hanging parts thereon to wash, the rack comprising:
three leg members each having a top end and a bottom end, the top ends of the three leg members being configured to be rotatably coupled proximate one another such that the bottom ends of the three leg members are selectively rotatable outward from a storage position to form a tripod arrangement, and the leg members being angled by a longitudinal bend to have two outer surfaces facing in different directions;
a plurality of openings formed along a length of each outer surface of each of the leg members; and
a plurality of hook members configured to be selectively installed in, and removed from, the openings in the leg members so as to selectively hang parts therefrom;
wherein the three leg members are configured such that parts may be hung from three sides of the rack simultaneously.
